(19) United States
(12) Patent Application Publication
(10) Pub. No.: US 2026/0365141 A1
(43) Pub. Date: Nov. 19, 2026

(54) ADAPTER FOR WIPER

(71) Applicant: CAP CORPORATION, Sangju-si (KR)

(72) Inventor: Myoung-Yeon KIM, Sangju-si (KR)

(73) Assignee: CAP CORPORATION, Sangju-si (KR)

(21) Appl. No.: 19/280,896

(22) Filed: Jul. 25, 2025

(30) Foreign Application Priority Data
May 19, 2025 (KR) 10-2025-0064491

(51) Int. Cl. B60S 1/40

(52) U.S. Cl. CPC B60S 1/4045

(57) ABSTRACT

An adapter for connecting a longitudinally extended wiper blade to a wiper arm, includes: a body coupled with the wiper blade and to which the wiper arm is detachably connected; a locking cap slidably coupled to the front portion of the body and having a cap protrusion protruding rearward at its lower part; and a rear spacer detachably coupled to the rear portion of the body and having a rear spacer protrusion protruding outward from the rear end side.

### CROSS-REFERENCE TO RELATED APPLICATION

This application claims priority from Korean Patent Application No. 10-2025-0064491 (filed on May 19, 2025), which is hereby incorporated by reference in its entirety.

### BACKGROUND

The present disclosure relates to an adapter for a wiper, and more specifically, to an adapter for connecting a wiper arm and a wiper blade to each other.

Generally, a wiper device is installed on a vehicle to wipe a surface of a windshield. The wiper device includes a wiper motor, a wiper arm, a wiper blade, etc., and an adapter is used for structural connection between the wiper arm and the wiper blade.

The wiper arm is connected to a rotational shaft of the wiper motor at a base of the arm and reciprocates under an operation of the wiper motor, and may include one or more wiper arm depending on a size of the windshield. When the two wiper arms are provided, they are arranged so that movements thereof do not interfere with each other.

The wiper blade is detachably connected to an end of the wiper arm via the adapter. The wiper blade is provided in a straight shape and maintains a state of close contact with the windshield, and slides and wipes the surface of the windshield under the movement of the rotating wiper arm.

The wiper blade is installed on the vehicle and is continuously rubbed against the windshield. Thus, over time, the blade may wear out, and generate unnecessary noise, or its surface-wiping performance thereof may deteriorate.

Therefore, the wiper blade needs to be continuously replaced. To this end, the vehicle user removes the existing wiper blade from the wiper arm and attaches a new wiper blade thereto using the adapter.

Since wiper arms have various shapes depending on types thereof, the adapter of a structure suitable for the wiper arm is required. In addition, the adapter should make it easy to replace the wiper blade and should allow a state in which the wiper blade attached to the wiper arm is in close contact with the windshield to be stably maintained under wind resistance, etc.

Therefore, development has been done on a structure of the adapter that effectively connects the wiper blade to the wiper arm in consideration of the shape of the wiper arm.

### SUMMARY

A purpose of the present disclosure is to provide an adapter for a wiper that ensures a strong fastening force with various types of wiper arms.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

In order to achieve the above purpose, an adapter for connecting a longitudinally extended wiper blade to a wiper arm according to an embodiment of the present disclosure includes, a body coupled with the wiper blade and to which the wiper arm is detachably connected; a locking cap slidably coupled to the front portion of the body and having a cap protrusion protruding rearward at its lower part; and a rear spacer detachably coupled to the rear portion of the body and having a rear spacer protrusion protruding outward from the rear end side.

Specific details of other embodiments are included in the detailed description and drawings.

According to the adapter of the present disclosure, following effects may be achieved.

First, various types of wiper arms can be connected using various spacers.

Second, the rear spacer is detachable, allowing for fixing the wiper arm or preventing interference depending on the type of wiper arm.

Third, a cap protrusion is formed on the locking cap that suppresses clearance and avoids interference, depending on the type of wiper arm.

The effects of the present disclosure are not limited to the effects as mentioned above, and other effects not mentioned above will be clearly understood by those skilled in the art from following descriptions.

In addition to the above-described effects, the specific effects of the present disclosure are described below while describing specific details for implementing the embodiments of the present disclosure.

### BRIEF DESCRIPTION OF DRAWINGS

FIG. 1 is a partial perspective view of a wiper device according to an embodiment of the present disclosure.

FIGS. 2 and 3 are exploded views of an adapter according to an embodiment of the present disclosure.

FIGS. 4A - 4C are diagrams showing a first type of wiper arm being connected to the adapter in the wiper device according to an embodiment of the present disclosure.

FIGS. 5A - 5C are diagrams showing a second type of wiper arm being connected to the adapter in the wiper device according to an embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and embodiments of the present disclosure are not limited thereto.

The terminology used herein is directed to the purpose of describing particular embodiments only and is not intended to be limiting of the present disclosure. As used herein, the singular constitutes "a" and "an" are intended to include the plural constitutes as well, unless the context clearly indicates otherwise. It will be further understood that the terms "comprise", "comprising", "include", and "including" when used in this specification, specify the presence of the stated features, integers, operations, elements, and/or components, but do not preclude the presence or addition of one or more other features, integers, operations, elements, components, and/or portions thereof. As used herein, the term "and/or" includes any and all combinations of one or more of associated listed items. Expression such as "at least one of" when preceding a list of elements may modify the entire list of elements and may not modify the individual elements of the list. In interpretation of numerical values, an error or tolerance therein may occur even when there is no explicit description thereof.

In addition, it will also be understood that when a first element or layer is referred to as being present "on" a second element or layer, the first element may be disposed directly on the second element or may be disposed indirectly on the second element with a third element or layer being disposed between the first and second elements or layers. It will be understood that when an element or layer is referred to as being "connected to", or "connected to" another element or layer, it may be directly on, connected to, or connected to the other element or layer, or one or more intervening elements or layers may be present. In addition, it will also be understood that when an element or layer is referred to as being "between" two elements or layers, it may be the only element or layer between the two elements or layers, or one or more intervening elements or layers may also be present.

Further, as used herein, when a layer, film, region, plate, or the like is disposed "on" or "on a top" of another layer, film, region, plate, or the like, the former may directly contact the latter or still another layer, film, region, plate, or the like may be disposed between the former and the latter. As used herein, when a layer, film, region, plate, or the like is directly disposed "on" or "on a top" of another layer, film, region, plate, or the like, the former directly contacts the latter and still another layer, film, region, plate, or the like is not disposed between the former and the latter. Further, as used herein, when a layer, film, region, plate, or the like is disposed "below" or “under” another layer, film, region, plate, or the like, the former may directly contact the latter or still another layer, film, region, plate, or the like may be disposed between the former and the latter. As used herein, when a layer, film, region, plate, or the like is directly disposed "below" or "under" another layer, film, region, plate, or the like, the former directly contacts the latter and still another layer, film, region, plate, or the like is not disposed between the former and the latter.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms "first", "second", "third", and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

It will be understood that when an element or layer is referred to as being "connected to", or "connected to" another element or layer, it may be directly on, connected to, or connected to the other element or layer, or one or more intervening elements or layers may be present. In addition, it will also be understood that when an element or layer is referred to as being "between" two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, “A and/or B” means A, B or A and B, unless specifically stated otherwise. Expression such as "at least one of" when preceding a list of elements may modify the entirety of list of elements and may not modify the individual elements of the list. As used herein, "C to D" means C inclusive to D inclusive unless otherwise specified.

Hereinafter, the present disclosure will be described with reference to drawings for illustrating an adapter according to embodiments of the present disclosure.

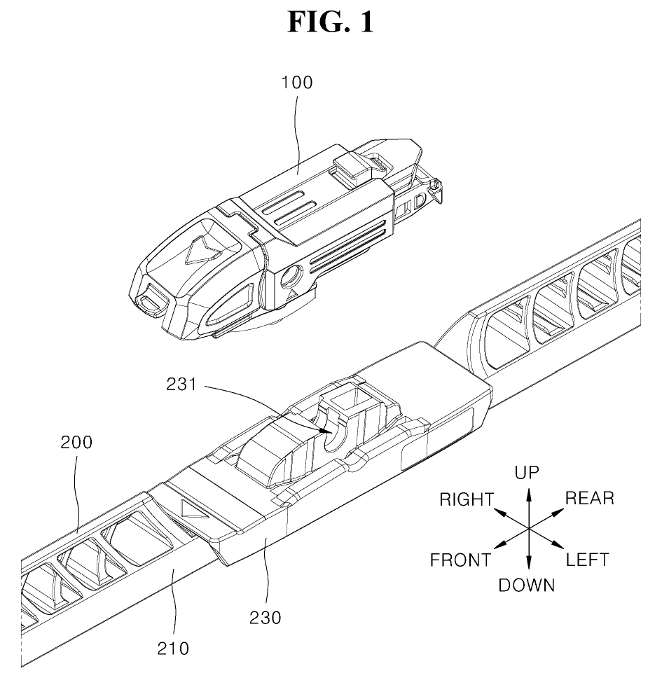

FIG. 1 is a partial perspective view of a wiper device according to an embodiment of the present disclosure.

The wiper device according to an embodiment of the present disclosure includes a longitudinally extended wiper blade 200 that cleans the surface of a target object, for example, a vehicle's windshield, by being in close contact with the surface of the target object, a wiper arm, not shown, that moves the wiper blade 200, and an adapter 100 that connects the wiper blade 200 to the wiper arm.

The wiper blade 200 includes a longitudinally extended blade part 210 and a base 230 provided at the middle of the blade part 210 and connected to the adapter 100.

The blade part 210 is long in the front-rear direction but has a bow shape that is curved according to the shape of the target object. Part of the blade part 210 is composed of an elastic member, and the elastic member is in close contact with the target object.

The base 230 is coupled to the blade part 210 and coupled to the adapter 100. The base 230 is rotatably relative to the adapter 100. A base holder 231, which is a roughly cylindrical hole open at the top where the adapter 100 is inserted, is formed in the base 230.

The wiper arm rotates around its base and has the wiper blade 200 connected to its end by the adapter 100, thereby moving the wiper blade 200. The wiper arm is detachably coupled to the adapter 100.

The wiper arm can have various structures at the end that connects to the adapter 100 depending on the target object, and in this embodiment, the adapter 100 is an omni-adapter that can connect to various types of wiper arms.

The adapter 100 connects various types of wiper arms to the wiper blade 200. The adapter 100 is rotatably coupled to the wiper blade 200. The adapter 100 is detachably coupled to the wiper arm.

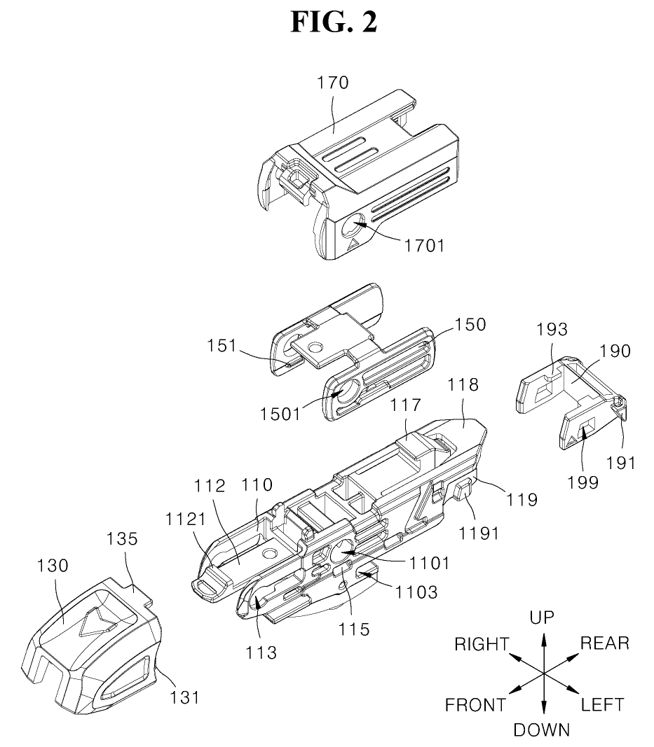

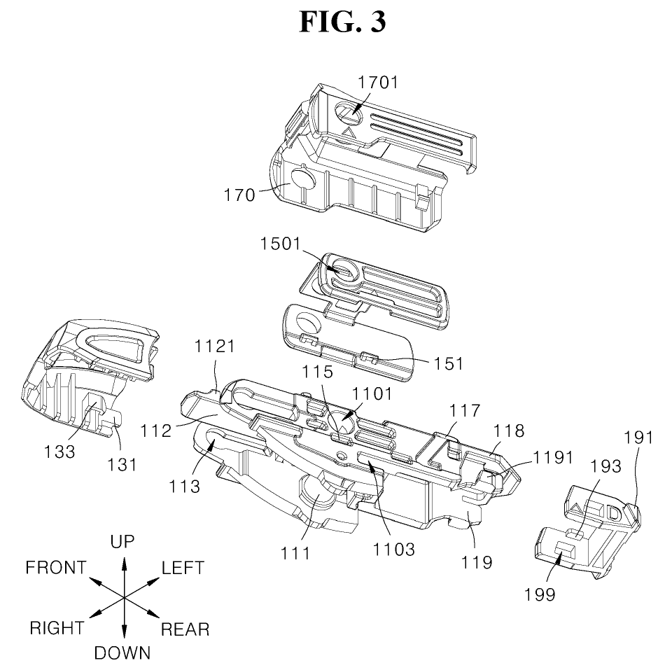

FIGS. 2 and 3 are exploded views of an adapter according to an embodiment of the present disclosure.

The adapter 100 according to an embodiment of the present disclosure comprises a body 110 that is rotatably coupled to the wiper blade 200 and to which the wiper arm is detachably connected, a locking cap 130 that is slidably coupled to the front portion of the body 110, a rear spacer 190 that is detachably coupled to the rear portion of the body 110, a middle spacer 150 that is detachably coupled to the middle portion of the body 110, and a cover 170 that covers at least part of the middle spacer 150 and is detachably coupled to the body 110.

The body 110 is rotatably coupled to the base 230 of the wiper blade 200. The body 110 is inserted into the base holder 231 of the base 230. The body 110 consists of both sides, left and right sides, and an upper surface. The locking cap 130 is slidably coupled to the front portion of the body 110. The rear spacer 190 is detachably coupled to the rear portion of the body 110. The middle spacer 150 and the cover 170 are detachably coupled to the middle portion of the body 110.

The body 110 includes a blade coupling shaft 111 that is rotatably coupled to the wiper blade 200, a center hole 1101 that penetrates the sides of the body 110 in the width direction, left-right direction, a body tongue 112 that is placed between both sides, left and right sides, of the front portion of the body 110 and extends long toward the front, a guide hole 113 placed in the front portion of the body 110 and long in the front-rear direction, a leg 119 extending long toward the rear, a rear top 118 that extends toward the rear and is placed above the leg 119 and is spaced apart from the leg 119, a rear hook 117 placed at the front end of the rear top 118 and protruding upward, multiple body grooves 115 placed in the middle portion of the body 110 and indented inward from the sides, and a curved groove 1103 formed by the sides of the body 110 being carved toward the front.

The blade coupling shaft 111 is cylindrical with the width direction (left-right direction) of the body 110 as its center, and is inserted into the base holder 231 of the base 230. The blade coupling shaft 111 is rotatably coupled to the base holder 231, so the adapter 100 and the wiper blade 200 are rotatably coupled.

The front and rear portions of the adapter 100 (or body 110) are determined based on the rotation center of the blade coupling shaft 111, and the blade coupling shaft 111 part corresponds to the middle portion of the adapter 100 (or body 110), the front from the blade coupling shaft 111 corresponds to the front portion of the adapter 100 (or body 110), and the rear from the blade coupling shaft 111 corresponds to the rear portion of the adapter 100 (or body 110). Also, the rotation center of the adapter 100 (or body 110) refers to the rotation center of the blade coupling shaft 111.

The blade coupling shaft 111 is placed in the middle portion of the body 110. The blade coupling shaft 111 is placed below the center hole 1101. The blade coupling shaft 111 is placed below one of the plurality of body grooves 115. The blade coupling shaft 111 is placed behind the body tongue 112. The blade coupling shaft 111 is placed behind the guide hole 113. The blade coupling shaft 111 is placed in front of the rear top 118. The blade coupling shaft 111 is placed in front of the rear hook 117. The blade coupling shaft 111 is placed in front of the leg 119.

The center hole 1101 is placed in the middle portion of the body 110 and is a cylindrical hole that penetrates both sides of the body 110 in the width direction (left-right direction) to connect a specific type of wiper arm. The center hole 1101 is placed above the blade coupling shaft 111. The center hole 1101 is placed above one of the plurality of body grooves 115. The center hole 1101 is placed behind the body tongue 112. The center hole 1101 is placed behind the guide hole 113. The center hole 1101 is placed in front of the rear top 118. The center hole 1101 is placed in front of the rear hook 117. The center hole 1101 is placed in front of the leg 119. The center hole 1101 is placed above the front end of the curved groove 1103.

The body tongue 112 is placed in the front portion of the body 110. The body tongue 112 is a button that fixes and releases the locking cap 130. The body tongue 112 is placed between a pair of guide holes 113. The body tongue 112 has a tongue protrusion 1121 formed that protrudes upward. The tongue protrusion 1121 catches on the locking cap 130 when the locking cap 130 slides to the maximum rear position. When the tongue protrusion 1121 is caught on the locking cap 130, the front end of the tongue protrusion 1121 protrudes further forward than the front end of the locking cap 130. Accordingly, the user can push down the front end of the tongue protrusion 1121 to release the locking cap 130 and slide it forward.

The guide hole 113 is placed in the front portion of the body 110. The guide hole 113 has the cap insert 133 inserted and guides the locking cap 130 to slide in the front-rear direction. The guide hole 113 is a long hole in the front-rear direction, and the front end is formed in a circular shape with a diameter larger than the vertical width of the middle and rear ends. Accordingly, the locking cap 130 can rotate when it is slid to the maximum forward position. The guide hole 113 is provided as a pair on both sides, left and right sides, of the body 110.

The curved groove 1103 is placed in the middle portion of the body 110 and is formed by the sides of the body 110, left side and/or right side, being carved toward the front to connect a specific type of wiper arm. The front end of the curved groove 1103 is placed behind the center of the blade coupling shaft 111. The curved groove 1103 is placed above the center of the blade coupling shaft 111. The curved groove 1103 is provided as a pair on both sides, left and right sides, of the body 110.

The leg 119 is placed in the rear portion of the body 110 and is formed by the sides of the body 110, left side and/or right side, extending long toward the rear. The leg 119 is formed to have elasticity in the width direction, left-right direction, of the body 110. The leg 119 is placed below the rear top 118 spaced apart from the rear top 118. The leg 119 is provided as a pair on both sides, left and right sides, of the body 110.

The leg 119 has a leg protrusion 1191 formed that is formed to protrude outward from the side. The leg protrusion 1191 catches on a specific type of wiper arm to connect it or fixes the rear spacer 190. The leg protrusion 1191 is inserted into the rear spacer hole 199. The leg protrusion 1191 has a lower part that protrudes further forward than the upper part.

The rear top 118 is placed in the rear portion of the body 110 and is formed by the upper surface of the body 110 extending long toward the rear. The rear top 118 is placed below the rear hook 117 and above the leg 119 spaced apart from the leg 119. The rear top 118 catches on a specific type of wiper arm to connect it.

The rear hook 117 is placed in the rear portion of the body 110 and is formed by protruding upward from the upper surface of the body 110. The upper end of the rear hook 117 is the highest part of the body 110. However, the upper end of the rear hook 117 is placed at a similar or higher position as the highest part of the locking cap 130. The rear hook 117 is formed to have elasticity in the vertical direction. The rear hook 117 catches on a specific type of wiper arm to connect it. The rear hook 117 elastically supports a specific type of wiper arm.

The plurality of body grooves 115 are placed in the central and rear portions of the body 110. The plurality of body grooves 115 have the plurality of middle spacer protrusions 151 of the middle spacer 150 caught on them. At least one of the plurality of body grooves 115, the body groove 115 placed in the middle portion of the body 110, is placed above the blade coupling shaft 111 and below the center hole 1101. At least one of the plurality of body grooves 115 is placed between the center hole 1101 and the blade coupling shaft 111.

The locking cap 130 is placed in the front portion of the body 110 and is slidably coupled to the body 110 to connect with a specific type of wiper arm. The locking cap 130 consists of both sides, left and right sides, and an upper surface. The upper surface of the locking cap 130 is formed as an inclined surface that gets lower toward the front. The width between both sides, the left and right sides, of the locking cap 130 is formed wider than the width between both sides, left and right sides, of the body 110. The locking cap 130 is placed in front of the middle spacer 150. The locking cap 130 is placed in front of the cover 170.

The locking cap 130 has a cap protrusion 131 protruding rearward at its lower part, a cap insert 133 protruding inward from the side, and a cap tail 135 protruding rearward at its upper part.

The cap protrusion 131 is placed at the lower part, slightly above the lowest part, of the locking cap 130. The cap protrusion 131 does not protrude further rearward than the upper part of the locking cap 130, so it does not cause interference when a specific type of wiper arm is connected. The cap protrusion 131 is indented more inward than the other sides of the locking cap 130, the sides in front of the cap protrusion 131. The cap protrusion 131 protrudes more outward than the sides of the body 110, so that no clearance occurs when a specific type of wiper arm is connected. The cap protrusion 131 is placed behind the cap insert 133. The cap protrusion 131 is provided as a pair on both sides, left and right sides, of the locking cap 130.

The cap insert 133 is inserted into the guide hole 113 of the body 110 so that the locking cap 130 slides. The cap insert 133 is provided as a pair on both sides, left and right sides, of the locking cap 130.

The cap tail 135 is placed at the rear end of the upper surface of the locking cap 130. The cap tail 135 covers the front end of the upper surface of a specific type of wiper arm to prevent clearance. The rear end of the cap tail 135 is placed further rearward than the rear end of the cap protrusion 131.

The rear spacer 190 is for modifying the structure of the rear portion of the body 110. The rear spacer 190 is placed behind the middle spacer 150.

The rear spacer 190 has a rear spacer protrusion 191 protruding outward from the rear end side, a rear spacer hole 199 placed in front of the rear spacer protrusion 191 into which the leg protrusion 1191 of the body 110 is inserted, and a rear spacer insert 193 protruding inward from the upper side and inserted between the rear top 118 and the leg 119.

The middle spacer 150 is for increasing the thickness in the width direction, left-right direction, of the body 110, and consists of both sides, left and right sides, and a connector connecting them. The middle spacer 150 has multiple middle spacer protrusions 151 protruding inward from the sides and caught on the plurality of body grooves 115, and a middle spacer hole 1501 corresponding to the center hole 1101 and placed above at least one of the plurality of middle spacer protrusions 151.

The cover 170 is for increasing the thickness in the width direction, left-right direction, of the body 110 or for modifying the structure of the upper surface, and has a cover hole 1701 corresponding to the center hole 1101. The cover 170 covers most of the middle spacer 150 and part of the rear spacer 190.

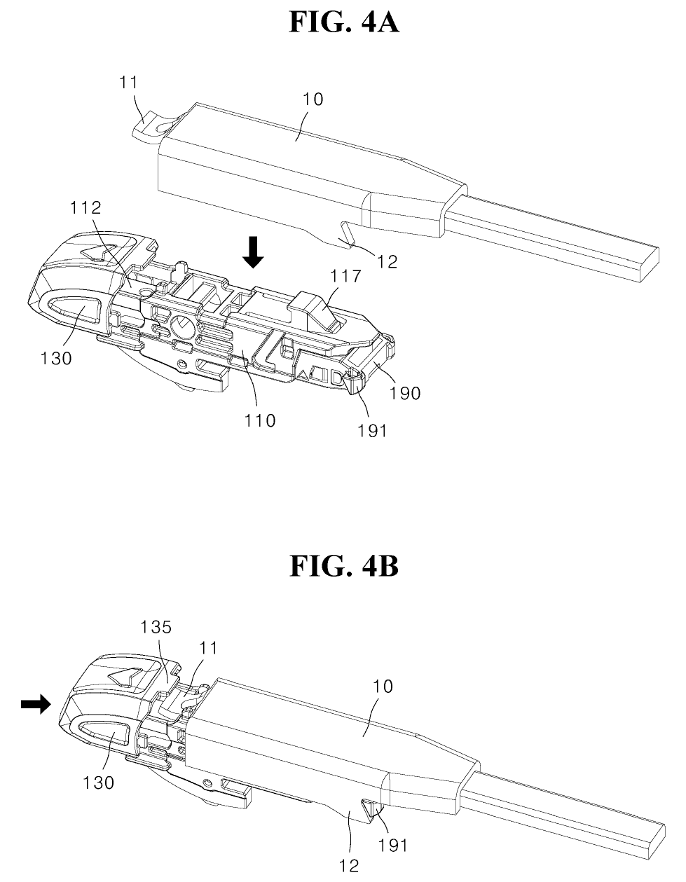

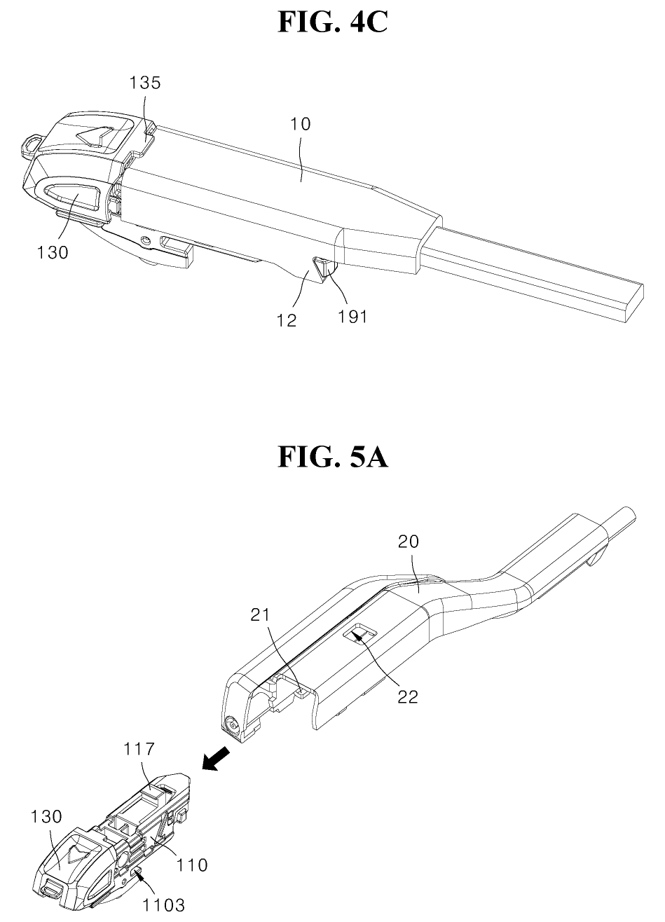

FIGS. 4A - 4C are diagrams showing a first type of wiper arm being connected to the adapter in the wiper device according to an embodiment of the present disclosure.

Referring to FIG. 4A, the first type of wiper arm 10 of the wiper device according to an embodiment of the present disclosure has a front portion consisting of an upper surface and both sides, left and right sides. The wiper arm 10 has an arm tongue 11 protruding forward at its front end and an arm protrusion 12 protruding obliquely downward.

As shown in FIG. 4A, the user presses the body tongue 112 to release the locking cap 130 and slides the locking cap 130 to the maximum forward position with the cover 170 and the middle spacer 150 of the adapter 100 removed.

When the user moves the wiper arm 10 downward, as shown in FIG. 4B, the rear spacer protrusion 191 and the arm protrusion 12 catch on each other, and the arm tongue 11 is placed above the body tongue 112. Also, the rear hook 117 elastically supports the wiper arm 10.

When the user slides the locking cap 130 rearward, the locking cap 130 is caught and fixed on the tongue protrusion 1121 of the body tongue 112, and as shown in FIG. 4C, the locking cap 130 covers and fixes the arm tongue 11 of the wiper arm 10, connecting the wiper arm 10 to the adapter 100. At this time, the cap tail 135 covers the front end of the upper surface of the wiper arm 10.

At this time, the cap protrusion 131 does not interfere with the wiper arm 10.

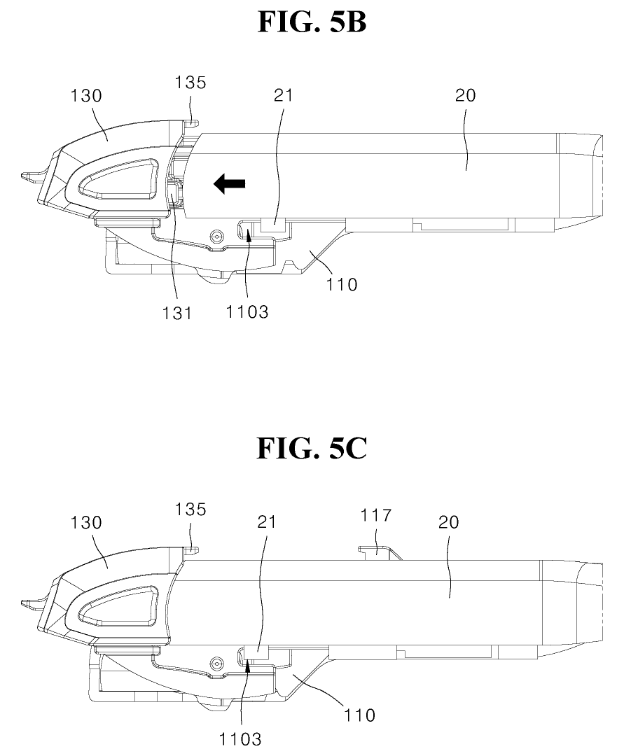

FIGS. 5A - 5C are diagrams showing a second type of wiper arm being connected to the adapter in the wiper device according to an embodiment of the present disclosure.

Referring to FIG. 5A, the second type of wiper arm 20 of the wiper device according to an embodiment of the present disclosure has a front portion consisting of an upper surface and both sides, left and right sides. The wiper arm 20 has an arm protrusion 21 protruding inward at its lower part and an arm hole 22 formed on its upper surface.

As shown in FIG. 5A, the user moves the wiper arm 20 forward with the cover 170, the middle spacer 150, and the rear spacer 190 of the adapter 100 removed.

As shown in FIGS. 5B and 5C, the arm protrusion 21 is inserted into the curved groove 1103, and the rear hook 117 is inserted into the arm hole 22, connecting the wiper arm 20 to the adapter 100.

At this time, the cap protrusion 131 supports the inner surface of the front end of the wiper arm 20 to suppress the occurrence of clearance. Also, the cap tail 135 is placed above the front end of the upper surface of the wiper arm 20.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above is not restrictive but illustrative in all respects.

1. An adapter for connecting a longitudinally extended wiper blade to a wiper arm, comprising:
a body coupled with the wiper blade and to which the wiper arm is detachably connected;
a locking cap slidably coupled to the front portion of the body and having a cap protrusion protruding rearward at its lower part; and
a rear spacer detachably coupled to the rear portion of the body and having a rear spacer protrusion protruding outward from the rear end side.

2. The adapter of claim 1, wherein the body has a leg extending rearward,
the leg has a leg protrusion protruding outward from the side, and
the rear spacer has a rear spacer hole placed in front of the rear spacer protrusion into which the leg protrusion is inserted.

3. The adapter of claim 2, wherein the body has a rear top extending rearward and placed above the leg, and
the rear spacer has a rear spacer insert protruding inward from the upper side and inserted between the rear top and the leg.

4. The adapter of claim 3, wherein the body has a rear hook placed at the front end of the rear top and protruding upward.

5. The adapter of claim 1, wherein the rear spacer protrusion has an upper part protruding further forward than the lower part.

6. The adapter of claim 1, wherein the cap protrusion does not protrude further rearward than the upper part of the locking cap.

7. The adapter of claim 1, wherein the cap protrusion is indented more inward than the other sides of the locking cap.

8. The adapter of claim 1, wherein the cap protrusion protrudes more outward than the sides of the body.

9. The adapter of claim 1, wherein the locking cap has a cap insert protruding inward from the side,
the body has a guide hole long in the front-rear direction into which the cap insert is inserted, and
the cap insert is placed in front of the cap protrusion.

10. The adapter of claim 1, further comprises, a middle spacer detachably coupled to the middle portion of the body,
wherein the middle spacer has a middle spacer protrusion protruding inward from the side,
the body has a blade coupling shaft rotatably coupled to the wiper blade and a body groove indented inward from the side and on which the middle spacer protrusion is caught, and
the body groove is placed above the blade coupling shaft.
